(19) United States
(12) Patent Application Publication
(10) Pub. No.: US 2025/0256339 A1
(43) Pub. Date: Aug. 14, 2025

(54) ROTARY CUTTING TOOLS WITH THROUGH COOLANT CHANNELS

(71) Applicant: Kennametal Inc., Latrobe, PA (US)

(72) Inventors: Logan M. Semnisky, Greensburg, PA (US); Alan J. Bookheimer, Greensburg, PA (US)

(21) Appl. No.: 18/437,945

(22) Filed: Feb. 9, 2024

(51) Int. Cl. B23C 5/28

(52) U.S. Cl. CPC B23C 5/283; B23C 5/282

(57) ABSTRACT

Rotary cutting tools with through coolant channels are disclosed. The rotary cutting tool includes a rear shank portion, a cutting portion with flutes extending from the shank portion along a longitudinal axis, at least one front end cutting edge, a central coolant channel extending along the shank portion and the cutting portion, and contoured radial coolant channels in flow communication with the central coolant channel. The contoured radial coolant channels extend from the central coolant channel to outlet ports adjacent the front end cutting edge(s). Additional radial coolant channels may also be provided in the cutting portion with outlet ports adjacent the flutes.

### FIELD OF THE INVENTION

The present invention relates to rotary cutting tools, such as end mills, with through coolant channels.

### BACKGROUND INFORMATION

End mills are used in the machine tool industry to cut various types of materials, including metals, carbon fiber, plastics and the like. These tools are often operated at high cutting temperatures in the cutting zone. The high temperatures may allow for increased removal rates of the material being cut and decreased force required to cut the material. However, the high cutting temperatures may also cause fatigue in such end mill cutting tools.

### SUMMARY OF THE INVENTION

The present invention provides rotary cutting tools such as end mills with through coolant channels. The rotary cutting tool includes a rear shank portion, a cutting portion with flutes extending from the shank portion along a longitudinal axis, at least one front end cutting edge, a central coolant channel that may extend along the longitudinal axis through the shank portion and the cutting portion, and radial coolant channels in fluid communication with the central coolant channel. The radial coolant channels extend from the central coolant channel to outlet ports adjacent the front end cutting edge(s). Additional radial coolant channels may also be provided in the cutting portion with outlet ports adjacent the flutes.

An aspect of the present invention is to provide a rotary cutting tool comprising: a shank portion; a cutting portion extending from the shank portion along a longitudinal axis comprising at least one flute and at least one peripheral cutting edge; at least one front end cutting edge at a front of the cutting portion; a central coolant channel extending within the shank portion; and at least one contoured radial coolant channel in fluid communication with the central coolant channel extending radially outward from the central coolant channel to a radial coolant channel outlet port adjacent the at least one front cutting edge or adjacent the at least one peripheral cutting edge. Multiple contoured radial coolant channels may be directed to multiple front end cutting edges, multiple contoured radial coolant channels may be directed to multiple flutes and peripheral cutting edges, or multiple sets of contoured radial coolant channels may be directed to both the front end cutting edges and the peripheral cutting edges.

These and other aspects of the present invention will be more apparent from the following description.

### BRIEF DESCRIPTION OF THE DRAWINGS

FIG. 1 is an isometric view of a rotary cutting tool with through coolant channels in accordance with an embodiment of the present invention.

FIG. 2 is an isometric view of the rotary cutting tool of FIG. 1 with the outer surface of the tool shown in phantom and the internal coolant channels shown with solid lines.

FIG. 3 is a side view of the rotary cutting tool of FIG. 1.

FIG. 4 is a side-sectional view of the rotary cutting tool taken through section 4-4 of FIG. 3.

FIG. 5 is a front end view of the rotary cutting tool of FIG. 1.

FIG. 6 is a rear end view of the rotary cutting tool of FIG. 1.

FIG. 7 is a cross-sectional view of the rotary cutting tool taken through section 7-7 of FIG. 3.

FIG. 8 is a cross-sectional view of the rotary cutting tool taken through section 8-8 of FIG. 3.

FIG. 9 is a cross-sectional view of the rotary cutting tool taken through section 9-9 of FIG. 3.

FIG. 10 is a cross-sectional view of the rotary cutting tool taken through section 10-10 of FIG. 3.

FIG. 11 is a cross-sectional view of the rotary cutting tool taken through section 11-11 of FIG. 3.

FIG. 12 is an isometric view illustrating a central coolant channel and radial coolant channels of the rotary cutting tool of FIG. 1.

FIG. 13 is a closeup view of a portion of FIG. 12.

FIG. 14 is an isometric view of radial coolant channels having outlet port openings with contoured ends in accordance with an embodiment of the present invention.

FIG. 15 is an isometric view of a rotary cutting tool with through coolant channels in accordance with another embodiment of the present invention.

FIG. 16 is an isometric view of the rotary cutting tool of FIG. 15 with the outer surface of the tool shown in phantom and the internal coolant channels shown with solid lines.

FIG. 17 is a side view of the rotary cutting tool of FIG. 15.

FIG. 18 is a side-sectional view of the rotary cutting tool taken through section 18-18 of FIG. 17.

FIG. 19 is a front end view of the rotary cutting tool of FIG. 15.

FIG. 20 is a rear end view of the rotary cutting tool of FIG. 15.

FIG. 21 is an isometric view illustrating a central coolant channel and radial coolant channels of the rotary cutting tool of FIG. 15.

### DETAILED DESCRIPTION

Rotary cutting tools of the present invention address the issues mentioned above by providing tools that may allow for increased cooling of cutting edges with controlled coolant fluid flow during operating conditions. As used herein, the term “fluid” may refer to water, oils, or other liquids, and/or gas that may pass through the through rotary cutting tools.

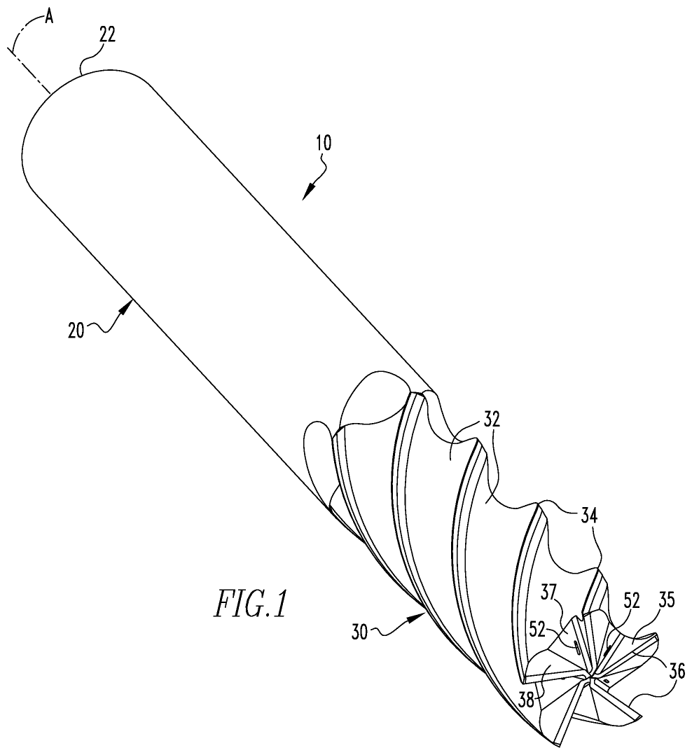

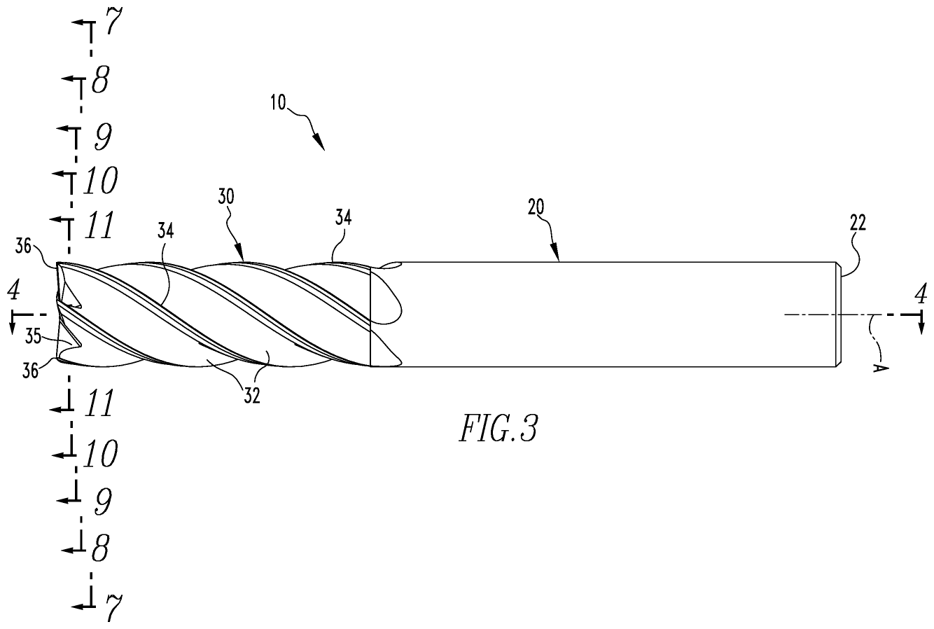

Referring to FIGS. 1-4, a rotary cutting tool 10, such as an end mill, includes a shank portion 20 with a rear shank face 22 and a cutting portion 30 extending forward from the shank portion 20 along a longitudinal axis A. The shank portion 20 and cutting portion 30 may be cylindrical in shape. The cutting portion 30 includes flutes 32 and peripheral cutting edges 34. Although helical flutes 32 are shown in the figures, it is to be understood that any other suitable flute shape may be used, such as straight flutes. The cutting portion 30 may include one, two, three, four, five or more flutes 32.

As shown in FIGS. 1-5, the rotary cutting tool 10 may include front end cutting edges 36 structured and arranged to cut a material at the end face of the cutting portion 30 during operation of the rotary cutting tool 10. The end cutting edges 36 may extend radially outward from the longitudinal axis A to a radial outermost surface of the cutting portion 30. An undercut rake face 35 extends axially rearward from each end cutting edge 36. The cutting portion may include one, two, three, four, five or more front end cutting edges.

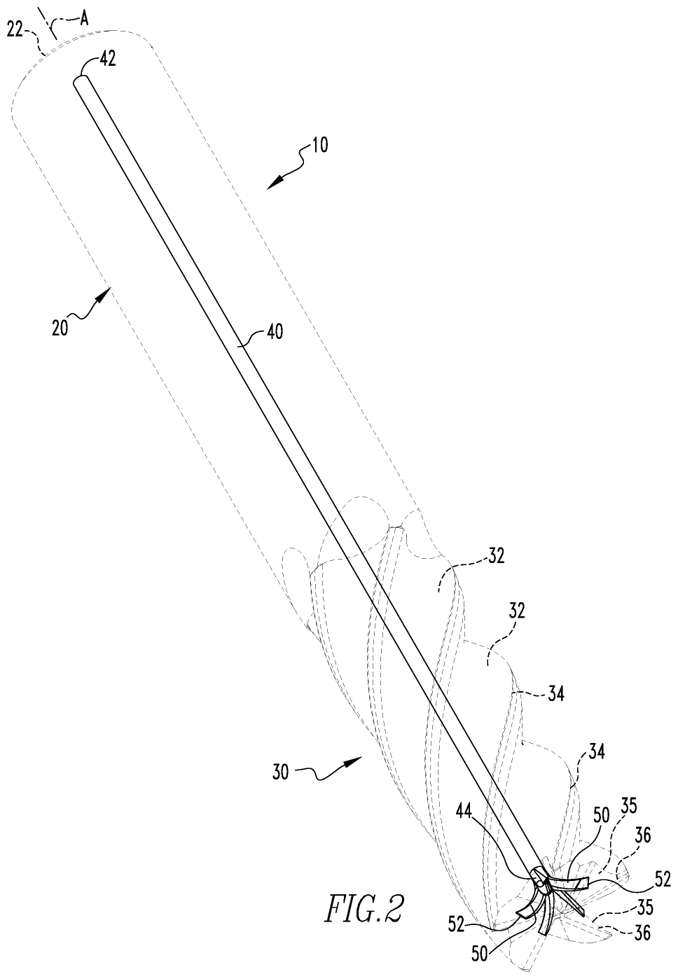

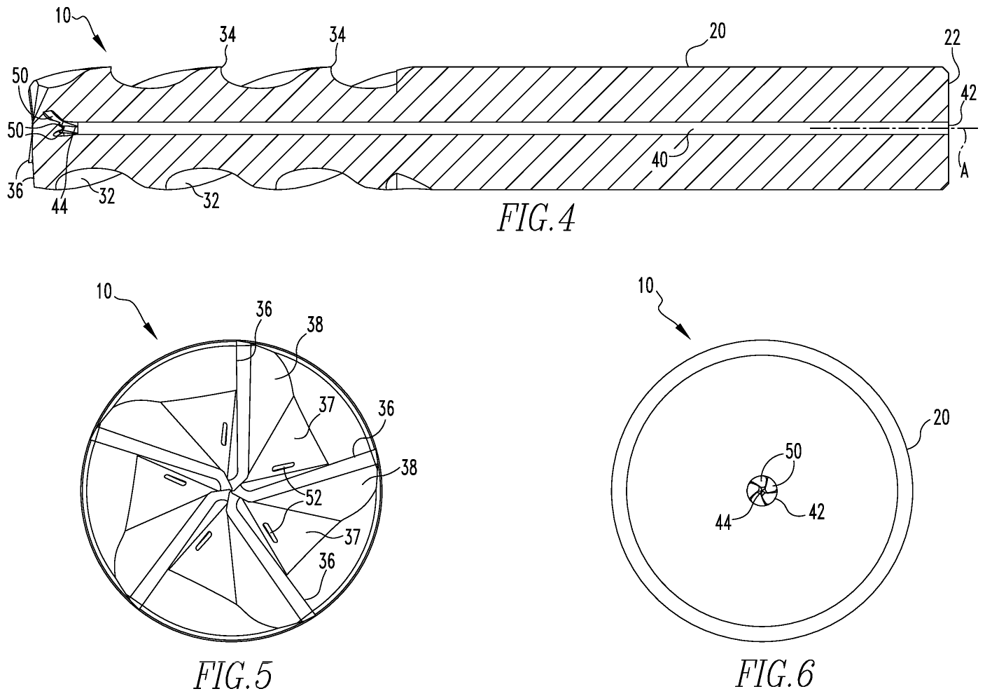

As shown in FIGS. 2 and 4, the shank portion 20 may include a central coolant channel 40 extending through the interior of the shank portion 20 along the longitudinal axis A. The central coolant channel 40 extends from a rear coolant channel inlet 42 located at the shank rear surface 22 through the shank portion 20 and into the cutting portion 30 toward the front end cutting edges 36. The central coolant channel 40 may be cylindrical in shape or any other suitable shape. As shown in FIGS. 4 and 6, the central coolant channel 40 extends to a coolant manifold 44 located in the cutting portion 30.

The central coolant channel 40 is structured and arranged to receive a coolant fluid during operation of the rotary cutting tool 10, which flows through the central coolant channel 40 to the coolant manifold 44. The central coolant channel 40 may be structured and arranged to receive coolant fluid from a fluid source (not shown).

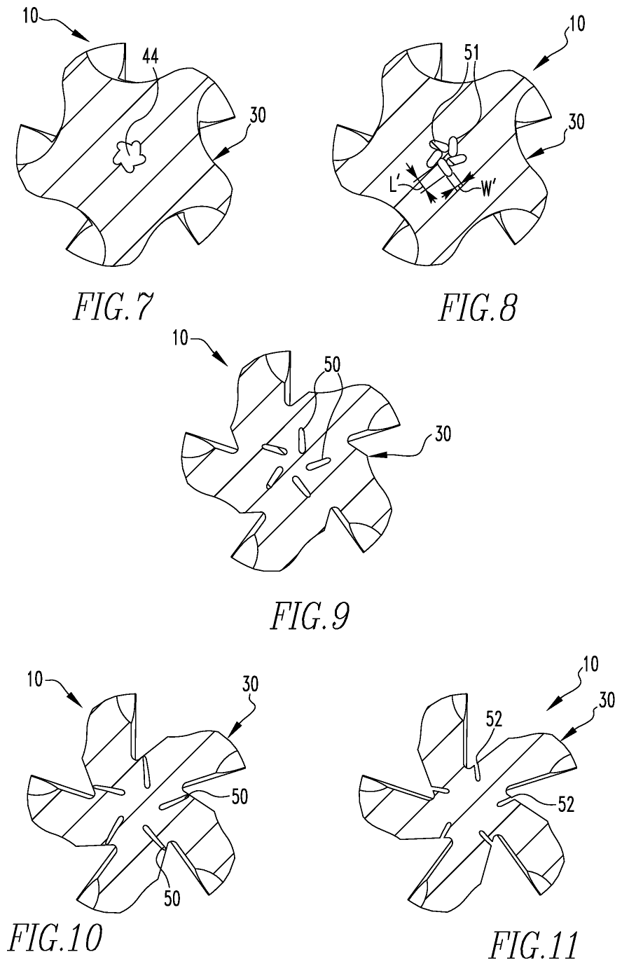

As shown in FIGS. 2, 12 and 13, contoured radial coolant channels 50 are in fluid communication with the internal central coolant channel 40. Each contoured radial coolant channel 50 begins at a radial coolant channel inlet port 51 located adjacent the central coolant channel 40 and coolant manifold 44, and terminates at a radial coolant channel outlet port 52. The contoured radial coolant channels 50 are also shown in the sectional views of FIGS. 7-11 at different axial locations along the length of the cutting portion 30. FIG. 7 shows the coolant manifold 44, FIG. 8 shows the coolant channel inlet ports 51, FIGS. 9 and 10 show the contoured radial coolant channels 50, and FIG. 11 shows the coolant channel outlet ports 52.

As used herein, the term “radial”, when referring to the coolant channels, means that a channel extends in a direction having a component in a radial direction extending perpendicularly outward from the central longitudinal axis A. The term “contoured”, when referring to the radial coolant channels, means that at least a portion of the channel extends in a non-linear or non-straight direction along its flow path length and/or at least a portion of the channel has a non-uniform cross-section as the channel extends along its length from its inlet port to its outlet port.

FIGS. 1, 2 and 5 illustrate the radial coolant channel outlet ports 52 located adjacent the front end cutting edges 36 and directed radially and axially toward the undercut rake faces 35 at the front end of the cutting portion 30. A projecting front coolant delivery face 37 is provided between adjacent front end cutting edges 36 and has one of the radial coolant channel outlet ports 52 extending therethrough. Each front end cutting edge 36 has a trailing face 38 extending axially rearward from the front end cutting edge 36. As further shown in FIGS. 1 and 5, the undercut rake faces 35, projecting front coolant delivery faces 37 and trailing faces 38 intersect the flutes 32.

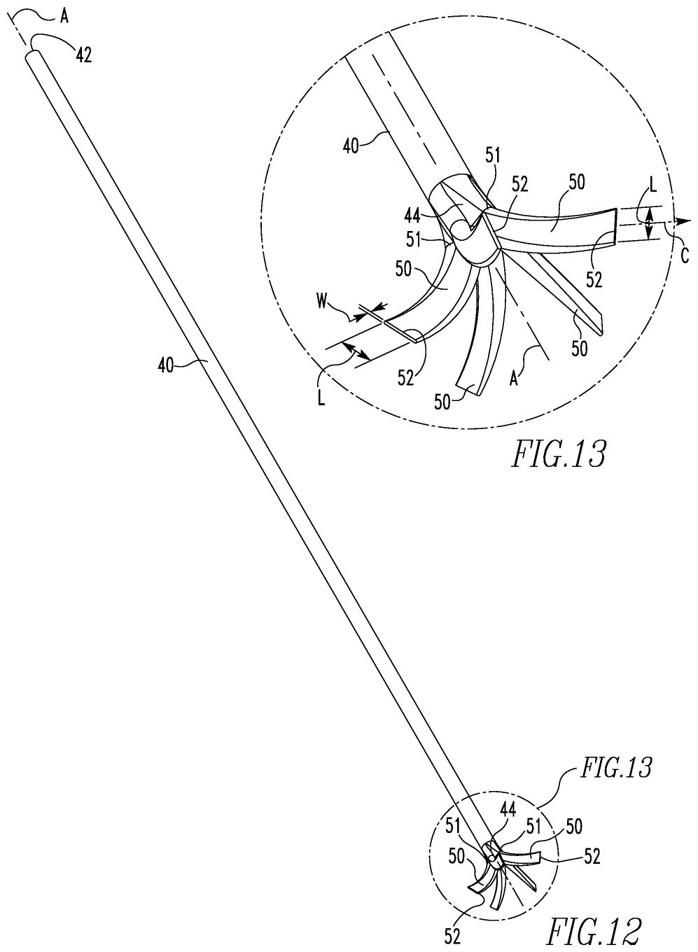

As schematically shown in FIGS. 12 and 13, each contoured radial coolant channel 50 and outlet port 52 defines a coolant flow direction C that may be controlled to provide improved cooling of the front end cutting edges 36, as more fully described below. As further shown in FIG. 13, each radial coolant channel outlet port 52 has an exit length L and an exit width W, having dimensions as more fully described below. As shown in FIG. 8, each coolant channel inlet port 51 has an inlet length L′ and an inlet width W′. The shape of each contoured coolant channel 50 may change over its length. For example, as the contoured coolant channels 50 extend from their inlet ports 51 to their outlet ports 52, L may increase in comparison to L′, and W may decrease in comparison to W′, creating a flat spray nozzle effect to cover more of the cutting edge length. Each contoured radial coolant channel 50 may have a first cross-sectional area aspect ratio L′:W′ adjacent the radial coolant channel inlet port 51 that transitions to a second cross-sectional area aspect ratio L:W adjacent the radial coolant channel outlet port 52, and the second cross-sectional area aspect ratio L:W may be greater than the first cross-sectional area aspect ratio L′:W′. Thus, the aspect ratio L:W may be greater than the aspect ratio L′:W′, i.e., L:W>L′:W′.

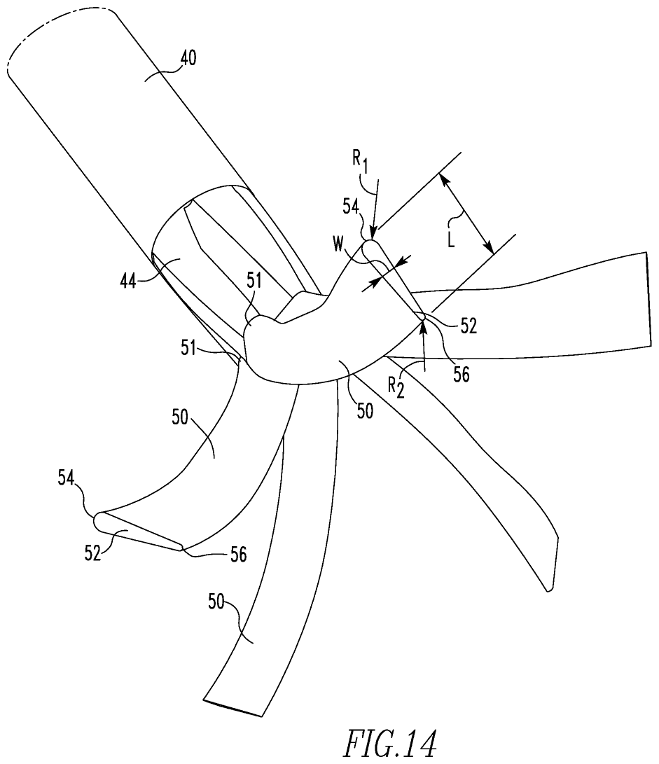

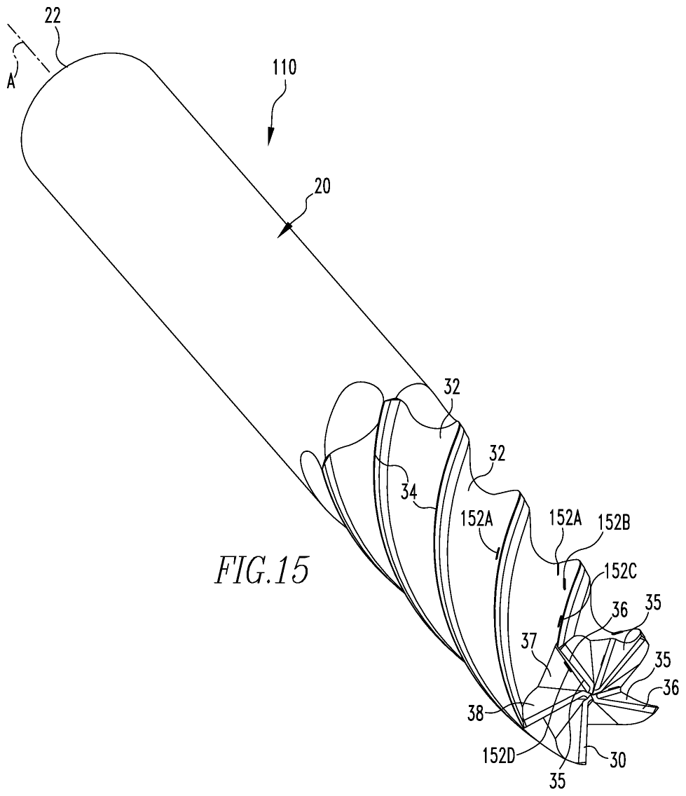

The radial coolant channel outlet ports may be slot shaped, tear-drop shaped, circular shaped, or may include another suitable cross-sectional shape. The exit length L measured in a cross-sectional plane of each outlet port may be longer than the exit width W measured in the cross-sectional plane. The exit width W may vary, for example, as shown in FIG. 14 where one end of the outlet port 52 has a radius R₁ that is greater than a radius R₂ at the opposite end of the outlet port, thereby providing a tear drop shape. The exit length L may typically range from 0.2 to 5 mm, for example, from 0.3 to 3 mm, or from 0.5 to 2 mm. The exit width W may typically range from 0.05 to 4 mm, for example, from 0.1 to 3 mm, or from 0.2 to 2 mm. The ratio of exit length to exit width L:W may typically range from 1:1 to 30:1, for example, from 2:1 to 20:1, or from 3:1 to 10:1.

The cross-sectional area of each outlet port 52 may be less than the cross-sectional area of the inlet 51 to each contoured radial coolant channel, e.g., at the intersection with the central coolant channel. A decrease in cross-sectional area of the contoured radial coolant channel may cause an increase in velocity of the coolant fluid as it flows through the contoured radial coolant channel. The fluid velocity may increase by a factor of from zero to 500 percent, for example, from 1.5 to 300 percent, or from 2 to 200 percent between the inlet of each radial coolant channel to its outlet port.

The shape of each radial channel outlet port may be structured and arranged to cause the coolant fluid to expand or fan out as it exits the outlet port. The coolant fluid may fan out in a direction parallel or substantially parallel with the peripheral cutting edge 34 or the front end cutting edges 36.

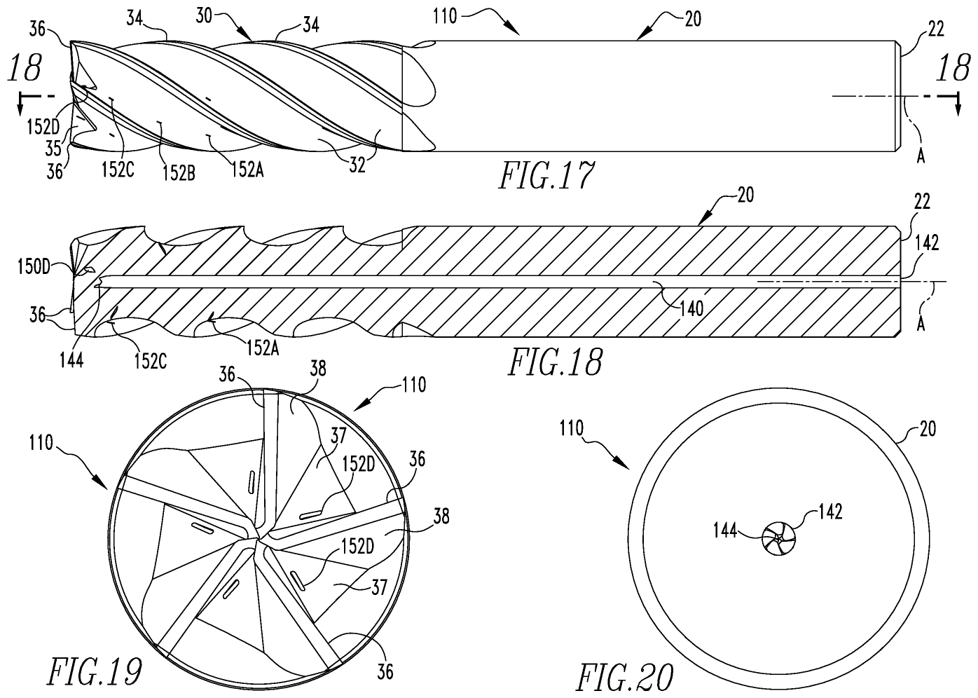

The contoured radial coolant channels illustrated in the embodiment of FIGS. 1-14, as well as the contoured radial coolant channels in the embodiments illustrated in FIGS. 15-21 described below, may have curved shapes which facilitate coolant flow patterns during operation of the rotary cutting tools. For example, in the embodiments shown, the contoured radial coolant channels have swept shapes in which their exit ports are circumferentially offset from their inlet ports. In the embodiments shown, the swept contoured radial coolant channels have exit ports that are circumferentially offset from their inlet ports in a direction opposite to the rotational direction of the cutting tool as it rotates around its central longitudinal axis A. Thus, during rotation of the cutting tool, the inlet port 51 of each contoured radial coolant channel 50 may circumferentially lead the outlet port 52 of the contoured radial coolant channel 50. Alternatively, the swept direction may be reversed, i.e., each inlet port 51 may circumferentially trail the outlet port 52. Any suitable circumferential offset distance may be used, such as at least 2°, or at least 5° or at least 10°, and up to 15°, or up to 20°, or up to 30° or more depending upon the particular configuration of the rotary cutting tool such as its number of end cutting edges.

FIGS. 15-21 illustrate a rotary cutting tool 110 in accordance with another embodiment of the present invention. In this embodiment, the rotary cutting tool 110 includes additional contoured radial coolant channels located adjacent the flutes 32, as more fully described below.

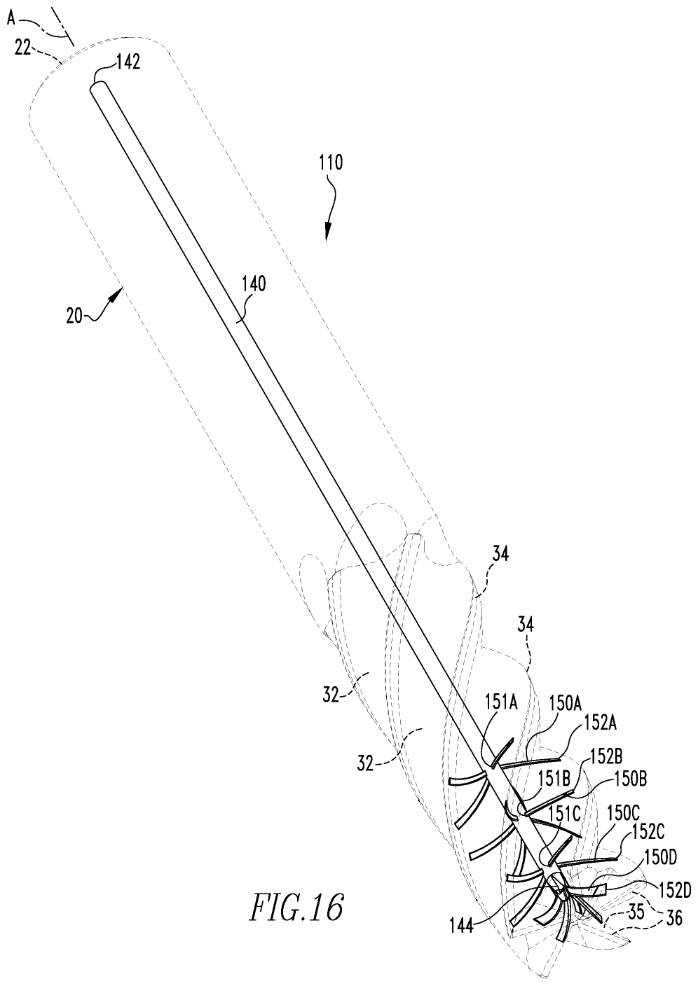

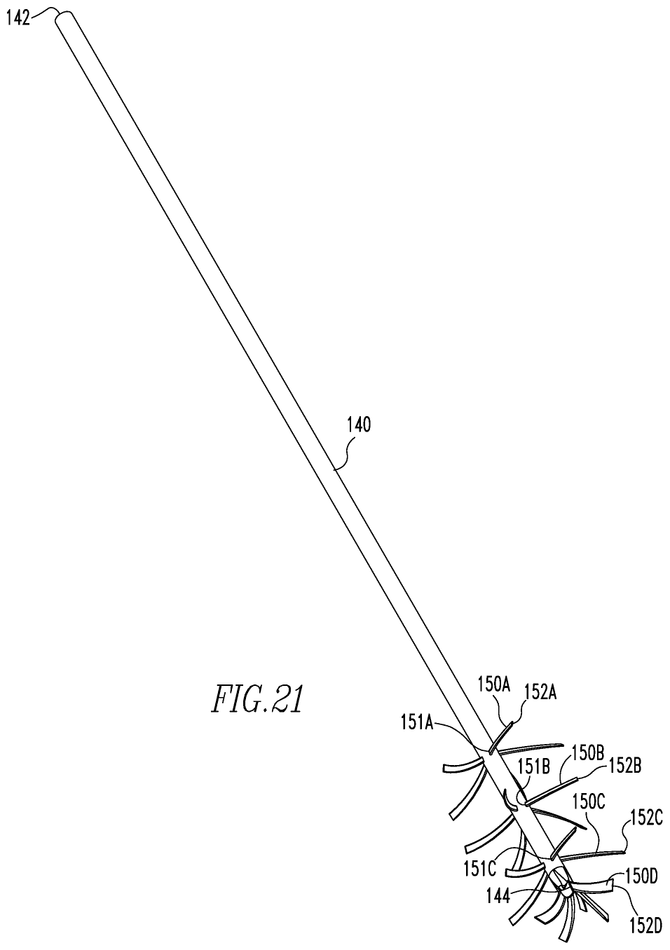

The rotary cutting tool 110 includes an internal central coolant channel 140 and a coolant channel inlet 142 located in the shank portion 20 and extending into the cutting portion 30. As shown most clearly in FIGS. 16 and 21, multiple contoured radial coolant channels 150A, 150B, 150C and 150D are provided at different locations along the central coolant channel 140.

At a first location along the longitudinal axis A of the rotary cutting tool 110, multiple first contoured radial coolant channels 150A extend radially from the central coolant channel 140 at first radial coolant channel inlets 151A. Each first contoured radial coolant channel 150A terminates at a first radial coolant channel outlet port 152A.

At a second location along the longitudinal axis A of the rotary cutting tool 110, multiple second contoured radial coolant channels 150B extend radially from the central coolant channel 140 via second radial coolant channel inlets 151B. Each second contoured radial coolant channel 150B terminates at a second radial coolant channel outlet port 152B.

At a third location along the longitudinal axis A of the rotary cutting tool 110, multiple third contoured radial coolant channels 150C extend radially from the central coolant channel 140 via third radial coolant channel inlets 151C. Each third contoured radial coolant channel 150C terminates at a third radial coolant channel outlet port 152C.

As further shown in FIGS. 16 and 21, a fourth set of contoured radial coolant channels 150D is provided. The multiple fourth contoured radial coolant channels 150D extend from a coolant manifold 144 that is in fluid communication with the central coolant channel 140. Each fourth contoured radial coolant channel 150D terminates at a fourth radial coolant channel outlet port 152D. As shown in FIGS. 15 and 19, each fourth radial coolant channel outlet port 152D extends through a corresponding projecting front coolant delivery face 37 in a similar manner as the embodiment shown in FIGS. 1-13.

The first, second and third contoured radial coolant channels 150A, 150B and 150C thus deliver coolant fluid at different axial positions in the flutes 32 directed toward the peripheral cutting edges 34, while the fourth contoured radial coolant channels 150D deliver coolant fluid toward the front end cutting edges 36.

The number of contoured radial coolant channels may equal the number of flutes 32, for example, as shown in the embodiment of FIGS. 1-13. Alternatively, the number of contoured radial coolant channels may be greater than the number of flutes 32, for example, as shown in the embodiment of FIGS. 15-21.

The contoured radial coolant channels 50 and 150D may be structured and arranged to cause the coolant fluid to cover a relatively large area of the front end cutting edges 36, for example, at least 5 percent of the front end cutting edges 36, for example, at least 10 percent, or at least 20 percent of the front end cutting edges 36. The contoured radial coolant channels 150A, 150B and 150C may be structured and arranged to cause the coolant fluid to cover a relatively large area of the peripheral cutting edges 34 of the flutes 32 during operation of the rotary cutting tools, for example, at least 2 percent of the peripheral cutting edges 34, for example, at least 5 percent, or at least 10 percent, or at least 20 percent of the peripheral cutting edges 34.

The rotary cutting tools 10 and 110 may be manufactured using any suitable manufacturing technique such as additive manufacturing. The entire rotary cutting tool may be manufactured with additive manufacturing, or only a portion of the cutting portion 30 may be manufactured with additive manufacturing. Non-limiting examples of additive manufacturing techniques include binder jetting, directed energy deposition (DED), material extrusion, material jetting, powder bed fusion, sheet lamination, and/or vat photopolymerization.

The use of additive manufacturing of the entire rotary cutting tool or the cutting portion may aid in forming the contoured radial coolant channels along the length of the central coolant channel. In some-nonlimiting embodiments, additive manufacturing may be used to form the cutting portion adjacent to the end face, such as the last 3-5 mm of the rotary cutting tool adjacent to the end face, by adding onto a solid carbide blank which includes the central coolant channel. The additive manufacturing may thus be selectively used to form the contoured radial coolant channels for flow communication with the pre-formed central coolant channel.

As used herein, “including,” “containing” and like terms are understood in the context of this application to be synonymous with “comprising” and are therefore open-ended and do not exclude the presence of additional undescribed or unrecited elements, materials, phases or method steps. As used herein, “consisting of” is understood in the context of this application to exclude the presence of any unspecified element, material, phase or method step. As used herein, “consisting essentially of” is understood in the context of this application to include the specified elements, materials, phases, or method steps, where applicable, and to also include any unspecified elements, materials, phases, or method steps that do not materially affect the basic or novel characteristics of the invention.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances. In this application and the appended claims, the articles “a,” “an,” and “the” include plural referents unless expressly and unequivocally limited to one referent.

Whereas particular embodiments of this invention have been described above for purposes of illustration, it will be evident to those skilled in the art that numerous variations of the details of the present invention may be made without departing from the invention as defined in the appended claims.

1. A rotary cutting tool comprising:
a shank portion;
a cutting portion extending from the shank portion along a longitudinal axis comprising at least one flute and at least one peripheral cutting edge;
at least one front end cutting edge at a front of the cutting portion;
a central coolant channel extending within the shank portion; and
at least one contoured radial coolant channel in fluid communication with the central coolant channel extending radially outward from the central coolant channel to a radial coolant channel outlet port adjacent the at least one front cutting edge or adjacent the at least one peripheral cutting edge.

2. The rotary cutting tool of claim 1, comprising a plurality of the front end cutting edges, contoured radial coolant channels and radial coolant channel outlet ports, and each radial coolant channel outlet port is directed toward a respective one of the front end cutting edges.

3. The rotary cutting tool of claim 2, wherein each of the front end cutting edges intersects an undercut rake face, and each of the contoured radial coolant channels is structured and arranged to deliver coolant fluid toward one of the front end cutting edges.

4. The rotary cutting tool of claim 3, further comprising a leading coolant delivery face circumferentially located between adjacent ones of the front end cutting edges, wherein one of the radial coolant channel outlet ports extends through the leading coolant delivery face and is structured and arranged to deliver the coolant fluid toward the adjacent front end cutting edge.

5. The rotary cutting tool of claim 1, comprising a plurality of the flutes, peripheral cutting edges, contoured radial coolant channels and radial coolant channel outlet ports, and each radial coolant outlet port is located in one of the flutes and directed toward a respective one of the peripheral cutting edges.

6. The rotary cutting tool of claim 5, wherein each of the contoured radial coolant channels is structured and arranged to deliver coolant fluid from its radial coolant channel outlet port toward the peripheral cutting edge.

7. The rotary cutting tool of claim 6, further comprising multiple sets of the contoured radial coolant channels located at different axial positions along the longitudinal axis of the cutting portion.

8. The rotary cutting tool of claim 7, comprising:
a first set of the contoured radial coolant channels located along the longitudinal axis structured and arranged to deliver coolant fluid toward the peripheral cutting edges; and
a second set of the contoured radial coolant channels located axially forward of the first set of the radial coolant channels along the longitudinal axis structured and arranged to deliver coolant fluid toward the peripheral cutting edges.

9. The rotary cutting tool of claim 8, further comprising a third set of the contoured radial coolant channels located axially forward of the second set of the radial coolant channels along the longitudinal axis.

10. The rotary cutting tool of claim 1, wherein the at least one flute is helical.

11. The rotary cutting tool of claim 1, comprising:
a plurality of the front end cutting edges, and a first plurality of the contoured radial coolant channels and radial coolant channel outlet ports, wherein each radial coolant outlet port of the first plurality radial coolant outlet ports is directed toward a respective one of the front end cutting edges; and
a plurality of the flutes and peripheral cutting edges, and a second plurality of the contoured radial coolant channels and radial coolant channel outlet ports, wherein each radial coolant outlet port of the second plurality of radial coolant outlet ports is located in one of the flutes and directed toward a respective one of the peripheral cutting edges.

12. The rotary cutting tool of claim 1, wherein the at least one contoured radial coolant channel extends forward along the longitudinal axis from an inlet adjacent the central coolant channel to the radial coolant channel outlet port.

13. The rotary cutting tool of claim 1, wherein the at least one contoured radial coolant channel comprises a non-linear curved portion along a length of the contoured radial coolant channel.

14. The rotary cutting tool of claim 13, wherein the non-linear portion extends along the entire length of the contoured radial coolant channel.

15. The rotary cutting tool of claim 13, wherein the at least one contoured radial coolant channel comprises a non-uniform cross-section along the length of the contoured radial coolant channel.

16. The rotary cutting tool of claim 1, wherein the at least one contoured radial coolant channel comprises a non-uniform cross-section along a length of the contoured radial coolant channel.

17. The rotary cutting tool of claim 1, wherein the at least one contoured radial coolant channel has a curved swept shape in which the radial coolant channel outlet port is circumferentially offset from a radial coolant channel inlet port of the contoured radial coolant channel.

18. The rotary cutting tool of claim 17, wherein the radial coolant channel outlet port is circumferentially offset from the radial coolant channel inlet port in a direction opposite to a rotational cutting direction of the rotary cutting tool.

19. The rotary cutting tool of claim 1, wherein the at least one contoured radial coolant channel comprises a first cross-sectional area aspect ratio adjacent a radial coolant channel inlet port of the contoured radial cooling channel that transitions to a second cross-sectional area aspect ratio adjacent the radial coolant channel outlet port, and the second cross-sectional area aspect ratio is greater than the first cross-sectional area aspect ratio.

20. The rotary cutting tool of claim 1, wherein the at least one radial coolant channel outlet port comprises a cross-sectional exit length that is greater than a cross-sectional exit width.

21. The rotary cutting tool of claim 1, wherein the at least one radial coolant channel outlet port has a tear drop shape.

22. The rotary cutting tool of claim 1, wherein a radial coolant channel inlet port of the at least one contoured radial coolant channel has an inlet cross sectional area greater than an exit cross sectional area of the radial coolant channel outlet port.

23. The rotary cutting tool of claim 1, wherein the rotary cutting tool is an end mill.
